(19) United States
(12) Patent Application Publication
(10) Pub. No.: US 2008/0063313 A1
(43) Pub. Date: Mar. 13, 2008

(54) IMAGE READING OPTICAL SYSTEM, IMAGE READING APPARATUS AND IMAGE FORMING APPARATUS

(76) Inventor: Kiichiro Nishina, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/851,846

(22) Filed: Sep. 7, 2007

(30) Foreign Application Priority Data
Sep. 8, 2006 (JP) 2006-244860

(51) Int. Cl. G06K 9/20

(52) U.S. Cl. 382/317

(57) ABSTRACT

An image reading optical system having an automatic text feeding device for automatically reading a front face and a back face of a text includes a first optical system for reading one face of the text and a second optical system for reading the other face of the text, each of the first optical system and the second optical system including an illumination system for illuminating a text, an imaging system for imaging reflection light of the text illuminated by the illumination system, and a line-sensor for photoelectrically converting an image of the text imaged by the imaging system, and the first optical system has an imaging magnification different from an imaging magnification of the second optical system.

### PRIORITY CLAIM

This application claims priority from Japanese Patent Application No. 2006-244860, filed with the Japanese Patent Office on Sep. 8, 2006, the contents of which are incorporated herein by reference in their entirety.

### BACKGROUND OF THE INVENTION

1. Field of the Invention

The present invention relates to an image reading optical system, an image reading apparatus and an image forming apparatus, more particularly, to a structure of an image reading optical system for simultaneously reading both sides of a sheet text.

2. Description of the Related Art

In a text reading unit or an image scanner disposed in a digital copying machine or a facsimile, image information to be read is reduced by a text reading lens, and the reduced information is imaged onto a line-sensor such as a CCD, so as to be photoelectrically converted. Moreover, there is a text reading apparatus for reading color text information. In such a text reading apparatus, for example, a 3-line CCD that line-sensors has a red filter, a green filter and a blue filter arranged in one chip is used, a text image is imaged onto the light receiving face of the sensors, so as to be decomposed into three colors, and the color image information is photoelectrically converted.

In such a text reading apparatus, in order to improve productivity for reading both sides of a sheet text, and to improve a so-called appliance for improving simplification and efficiency of an operation, a method of automatically reading both sides of a text is proposed. With the method of automatically reading both sides of a sheet text, at first, the front face of the text is read in an automatic text feeding device, and then the text is turned over in the text reading apparatus, and the back face of the text is read in the automatic text feeding device. However, with this method, the text is turned over in the automatic text feeding device, so there are problems in that text jamming and skewing occur when transferring the text, and it takes time for reading both sides of the text.

To solve the above problems, an image reading apparatus, in addition to a first optical system for reading a front face of a text, having a second optical system using a contact image sensor for reading a back face of a text is disclosed in JP H11-69086A, JP 2002-111974A, and JP 2002-101267A.

The contact image sensor has a conjugation length from the text face to the imaging face shorter than the reduced optical system, so the optical system can be downsized. However, since the contact image sensor has a shallow focal depth, it has a problem in that its performance is significantly deteriorated if the float and the thickness of the sheet text are changed when reading both sides of the sheet text. Also, it has a problem in that the color reproducibility is greatly different between the front face and the back face of the text because of the difference of the dispersion sensitivity of the sensor and the filter when reading the front face by the reduced optical system using the three-line CCD.

For the foregoing reasons, there is a need for a compact reading optical system capable of automatically reading both sides of a sheet text with high speed and high accuracy by a simple operation, which reads text images on both sides of the text by a single text transferring operation, without damaging the text, and for an image reading apparatus using the reading optical system.

There is also a need for a reading optical system which constitutes an imaging lens used for an optical system by means of a chemically stabilized optical glass free from harmful substances such as lead and arsenic, so as to enable recycling of the material and eliminate water pollution from waste fluid when processing.

### SUMMARY OF THE INVENTION

A first aspect of the present invention involves an image reading optical system having an automatic text feeding device for automatically reading a front face and a back face of a text and which includes a first optical system for reading one face of the text and a second optical system for reading the other face of the text, the first optical system having an illumination system for illuminating a text, an imaging system for imaging reflection light of the text illuminated by the illumination system, and a line-sensor for photoelectrically converting an image of the text imaged by the imaging system, and the second optical system having an illumination system for illuminating a text, an imaging system for imaging reflection light of the text illuminated by the illumination system, and a line-sensor for photoelectrically converting an image of the text imaged by the imaging system, wherein the first optical system has an imaging magnification different from an imaging magnification of the second optical system.

Preferably, the imaging system of the first optical system is a reduced optical system, and the imaging system of the second optical system is a reduced optical system. Preferably, when the text is a sheet text, the front face and the back face of the sheet text are read by a single transferring of the sheet text.

Preferably, either the first optical system or the second optical system is disposed in the automatic text feeding device.

Preferably, the line-sensor of either the first optical system or the second optical system has a zigzag alignment.

Preferably, the first optical system includes a color decomposition device in an optical path, and the second optical system includes a color decomposition device in an optical path.

Preferably, the imaging lens includes an imaging lens having a glass lens, and the glass lens includes a glass material which does not contain a harmful substance.

Preferably, each of the illumination system, the imaging system and the line-sensor of the first optical system includes a spectral characteristic, and each of the illumination system, the imaging system and the line-sensor of the second optical system includes a spectral characteristic, and a product of each of the spectral characteristics of the illumination system, the imaging system, and the line-sensor of the first optical system is substantially equal to a product of each of the spectral characteristics of the illumination system, the imaging system, and the line-sensor of the second optical system.

A second aspect of the present invention involves an image reading apparatus including an image reading optical system, the image reading optical system having an automatic text feeding device for automatically reading a front face and a back face of a text and which includes a first optical system for reading one face of the text and a second optical system for reading the other face of the text, the first optical system having an illumination system for illuminating a text, an imaging system for imaging reflection light of the text illuminated by the illumination system, and a line-sensor for photoelectrically converting an image of the text imaged by the imaging system, and the second optical system having an illumination system for illuminating a text, an imaging system for imaging reflection light of the text illuminated by the illumination system, and a line-sensor for photoelectrically converting an image of the text imaged by the imaging system, wherein the first optical system has an imaging magnification different from an imaging magnification of the second optical system.

A third aspect of the present invention involves an image forming apparatus including an image reading optical apparatus having an image reading optical system, the image reading optical system having an automatic text feeding device for automatically reading a front face and a back face of a text and which includes a first optical system for reading one face of the text, and a second optical system for reading the other face of the text, the first optical system having an illumination system for illuminating a text, an imaging system for imaging reflection light of the text illuminated by the illumination system, and a line-sensor for photoelectrically converting an image of the text imaged by the imaging system and the second optical system having an illumination system for illuminating a text, an imaging system for imaging reflection light of the text illuminated by the illumination system, and a line-sensor for photoelectrically converting an image of the text imaged by the imaging system, wherein the first optical system has an imaging magnification different from an imaging magnification of the second optical system.

### BRIEF DESCRIPTION OF THE DRAWINGS

These and other features, aspects, and advantages of the present invention will become better understood with regard to the following description, appended claims, and accompanying drawings.

FIG. 1 is an inside perspective view of an image reading apparatus according to an embodiment of the present invention.

FIG. 2 is a view illustrating a line-sensor having a zigzag alignment used for a line-sensor according to an embodiment of the present invention.

FIG. 3 is a perspective view illustrating a structure of a laser printer including the image reading apparatus according to an embodiment of the present invention.

### DETAILED DESCRIPTION OF THE INVENTION

Hereinafter, an embodiment of the present invention will be described with reference to the drawings. Although the present invention is described in terms of an exemplary embodiment, it is not limited thereto. It should be appreciated that variations may be made in the embodiment described by persons skilled in the art without departing from the scope of the present invention as defined by the following claims. In addition, the number, position, shape, or the like of the components are not limited to the following embodiment, and can be changed to a number, position, shape or the like of components preferable for realizing the present invention. Moreover, no element or component in the present disclosure is intended to be dedicated to the public regardless of whether the element or component is explicitly recited in the following claims.

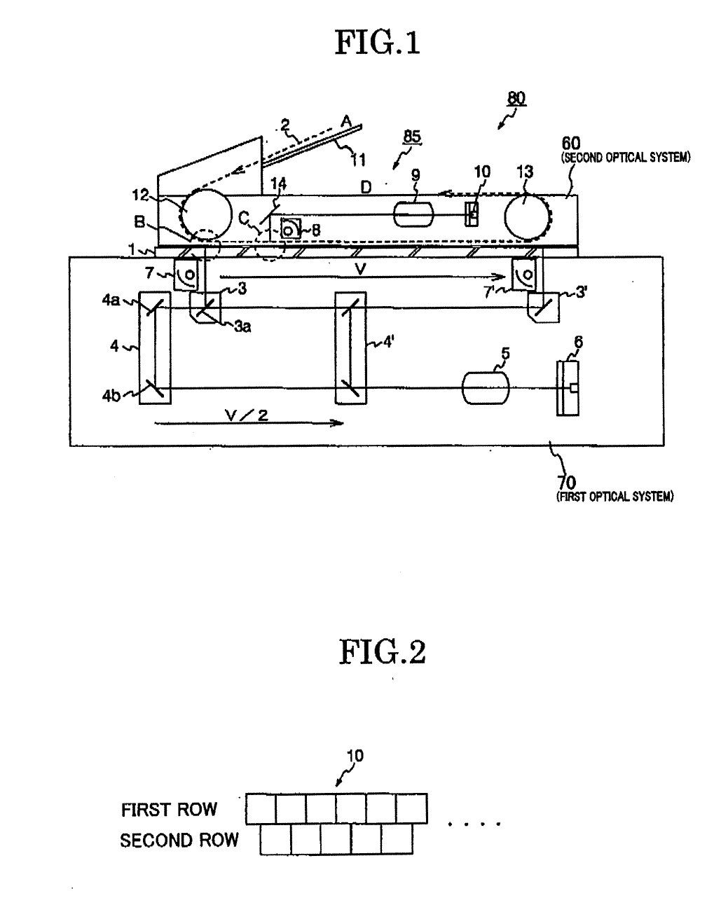

FIG. 1 is an inside perspective view of an image reading apparatus according to the embodiment of the present invention. An image reading apparatus (image reading optical system) 80 includes a first optical system 70 and a second optical system 60. The first optical system 70 includes a contact glass 1 on which a text is placed, an illumination system 7 for illuminating the text, a first running body 3, a second running body 4, an imaging lens 5 for reducing and imaging an image of the text, and a line-sensor 6. The second optical system 60 is disposed in an automatic text feeding device 85. The automatic text feeding device 85 includes a text tray 11 on which a sheet text 2 is placed, a transfer roller 12 for transferring the sheet text 2, an illumination system 8 for illuminating one face of the sheet text 2, a reflecting mirror 14 for reflecting the illuminated text image, an imaging lens 9 for reducing and imaging the text image, a line-sensor 10, and a discharging roller 13 for discharging the text.

As illustrated in FIG. 1, the sheet text 2 is transferred to the automatic text feeding device 85 from the direction A, and is transferred to the direction D by the transfer roller 12. In this case, the front face (back face) of the sheet text 2 is read in the position B by the first optical system 70 via the contact glass 1. After that, the back face (front face) of the sheet text 2 is read in the position C by the second optical system 60. Thereby, both sides of the sheet text 2 can be automatically read. The first optical system 70 illuminates the sheet text 2 by the illumination system 7, and projects the reflection light of the sheet text 2 to the imaging lens 5 for reducing and imaging the text image by means of reflection mirrors 3a, 4a, 4b, such that the text image is imaged onto the line-sensor 6.

The second optical system 60 illuminates the sheet text 2 by the illumination system 8, and images the reflection light of the sheet text 2 onto the line-sensor 10 by the imaging lens 9 for reducing and imaging the text image. In this case, the first optical system 70 has an imaging magnification different from an imaging magnification of the second optical system 60. In order to change the imaging magnification, for example, the reading density of the front face is set to be different from the reading density of the back face, or the pixel pitches of the line-sensors are set to be different to each other if the reading density of the front face and the back face are set to be equal. In addition, according to the present embodiment, in the second optical system 60, the reflection image of the text is directly imaged onto the line-sensor 10 by the imaging lens 9. However, a reflection mirror may be disposed between the imaging lens 9 and the text.

In order to make uniform the reading quality on the front face and the back face of the sheet text 2, it is preferable to make uniform the reading density of the front face and the back face, and also to make uniform the pixel pitches of the line-sensors. Consequently, in order to change the imaging magnification of the first optical system 70 and the second optical system 60, in the image reading apparatus 80, a line-sensor having a zigzag alignment such that the first row and the second row of the line-sensor 10 are misaligned at a half pixel as illustrated in FIG. 2 is used for the second optical system 60 for reading the back face of the sheet text 2. By using such a line-sensor 10 having a zigzag alignment, if the pixel pitches of the line-sensor 6 of the front face and the pixel pitches of the line-sensor 10 of the back face are made uniform, and even if the reading density of the back face is set to be half of the reading density of the front face, the text information of the back face can be read with a reading density equal to the reading density of the front face by calculating the input signals of the first row and the second row of the line-sensor 10.

When reading a book text, the text disposed on the contact glass 1 is illuminated by the illumination optical system 7 disposed under the contact glass 1. The illumination light of the text is reflected by the first mirror 3a of the first running body 3. After that, the reflected light is reflected by the first mirror 4a and the second mirror 4b of the second running body 4, and then the reflected light is led to the imaging lens 5, so as to be imaged onto the line-sensor 6 by the imaging lens 5. When reading the longitudinal direction of the text, the first running body 3 moves to a position 3′ at the speed of V, while the second running body 4 moves to a position 4′ at the half speed of the first running body, ½ V, so as to read the entire text.

Accordingly, the image reading apparatus 80 according to the present embodiment includes the first optical system 70 and the second optical system 60 for simultaneously reading both sides of the sheet text 2. The first optical system 70 includes the illumination system 7, the imaging lens (imaging system) 5, and the line-sensor 6. The second optical system 60 includes the illumination system 8, the imaging lens (imaging system) 9, and the line-sensor 10. When the second optical system 60 is disposed in the automatic text feeding device 85, the imaging magnification of the imaging lens 9 constituting the second optical system 60 is set to be smaller than the imaging magnification of the imaging lens 5 constituting the first optical system 70. By means of this structure, both sides of the sheet text 2 are automatically read by a single text transferring operation with high accuracy and high speed without damaging the sheet text 2. When the distance from the text face to the imaging lens is made uniform, for example, the focal length of the imaging lens 9 of the second optical system 60 can be reduced; thus, the outer shape of the lens is reduced. Consequently, the entire optical system can be downsized, so that the second optical system 60 can be disposed in the automatic text feeding device 85.

If the imaging magnification of the second optical system 60 is smaller than the imaging magnification of the first optical system 70, or if the imaging magnification of the second optical system 60 is larger than the imaging magnification of the first optical system 70, the second optical system 60 can be downsized. Therefore, the imaging magnification of the second optical system 60 is not limited to be smaller than the imaging magnification of the first optical system 70.

### (When the Imaging Magnification of the Second Optical System is Reduced)

In this case, the pixel size of the CCD and the field angle of the reading lens are fixed, and the reading density is reduced.

| | | | | Half Field | Focal | Con- |
|---|---|---|---|---|---|---|
| | Reading | CCD Pixel | Reduction | Angle of | Length | jugation |
| | Density | Size | Rate | Lens | of Lens | Length |
| First | 600 dpi | 4.7 μm | 0.11102 | 20 degrees | 41.842 | 465.2 |
| Optical | | | | | | |
| System | | | | | | |
| Second | 300 dpi | 4.7 μm | 0.05551 | 20 degrees | 22.021 | 442.0 |
| Optical | | | | | | |
| System | | | | | | |

By changing the reading density, the reduction rate can be reduced, as a result, if the half field angle of the lens is fixed, the focal length can be reduced. Accordingly, the reading lens can be downsized and also the conjugation length can be reduced.

According to the present embodiment, the reading quality can be made uniform by using the CCD having a zigzag alignment.

### (When the Imaging Magnification of the Second Optical System is Increased)

In this case, the reading density and the focal length of the lens are fixed, and the pixel size of the CCD is increased.

| | | CCD | | Half Field | Focal | Con- |
|---|---|---|---|---|---|---|
| | Reading | Pixel | Reduction | Angle of | Length | jugation |
| | Density | Size | Rate | Lens | of Lens | Length |
| First | 600 dpi | 4.7 μm | 0.11102 | 20 degrees | 41.842 | 465.2 |
| Optical | | | | | | |
| System | | | | | | |
| Second | 600 dpi | 7.0 μm | 0.16535 | 27.3 degrees | 41.842 | 343.6 |
| Optical | | | | | | |
| System | | | | | | |

By increasing the pixel size of the CCD, the reduction rate is increased, and the conjugation length can be significantly reduced. Moreover, since the reduction rate is increased, the width of the imaging face depth can be increased. Consequently, the influence can be reduced relative to the disturbance such as vibration.

When a line-sensor such as a CCD is used as a photoelectric conversion element, the text images are reduced by the imaging lenses 5, 9, and are focused onto the faces of the line-sensors 6, 10, respectively. In the present embodiment, since each of the optical systems uses the line-sensor, the imaging system becomes a reduced optical system. Therefore, the apparatus can be downsized.

When two optical systems are used, the text images on the both sides of the text can be read by the two optical systems with the single text transferring operation. Accordingly, the turning-over operation of the text becomes unnecessary, the transferring problems such as jamming and skewing are reduced, and also the reading operation time can be reduced.

In addition, in order to simultaneously read both sides of the text, it is necessary to dispose the second optical system 60 on the back face side of the text. Moreover, in order to transfer the sheet text 2, the automatic text feeding device 85 is required. Therefore, the second optical system 60 is disposed in the automatic text feeding device 85, so as to read the back face of the text by means of the second optical system 60. Consequently, the automatic text feeding device 85 can be effectively used, and the entire device can be downsized.

Furthermore, in order to read a full-color image, a color decomposition device such as a filter for decomposing a color into three primary colors is disposed in the optical path. By using a line-sensor for each of the colors, image information decomposed into three colors can be obtained. Therefore, a full color image can be read by the simple device.

In order to chemically stabilize the imaging lens for the optical system, harmful substances such as lead and arsenic may be contained in the imaging lens. In the present embodiment, by using the optical glass without containing such harmful substances, the material can be recycled, and the water pollution by the waste liquid when processing can be eliminated.

Each of the illumination system 7, the imaging lens 5, and the line-sensor 6 for constituting the first optical system 70 includes a specific spectral characteristic, and each of the illumination system 8, the imaging lens 9, and the line-sensor 10 for constituting the second optical system 60 includes a specific spectral characteristic. Especially, when reading full-color image information, it is important that the product of the specific spectral characteristics of the illumination system 7, the imaging lens 5, and the line-sensor 6 for constituting the first optical system 70 is equal to the product of the specific spectral characteristics of the illumination system 8, the imaging lens 9, and the line-sensor 10 for constituting the second optical system 60. In the present embodiment, the product of the spectral characteristics of the illumination system 7, the imaging lens 5, and the line-sensor 6 for constituting the first optical system 70 is almost equal to the product of the spectral characteristics of the illumination system 8, the imaging lens 9, and the line-sensor 10 for constituting the second optical system 60. Consequently, the color-reproducibility on the front face and the back face of the text can be made uniform with high accuracy.

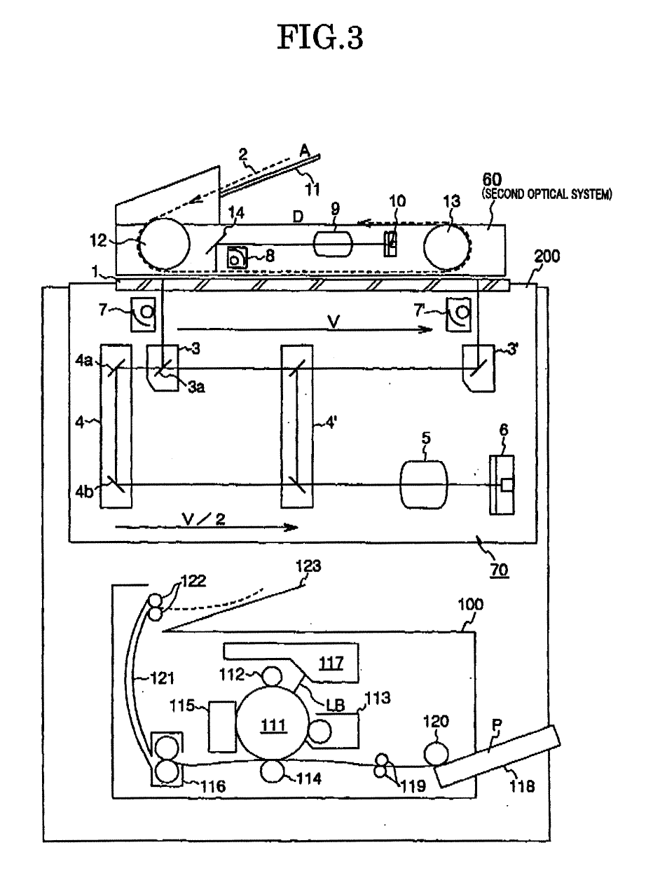

FIG. 3 is a perspective view illustrating a structure of a laser printer including the image reading apparatus of the present invention. A laser printer 100 (image forming apparatus) includes a photoconductor cylindrically formed as a latent image carrier 111. The latent image carrier 111 includes therearound a charging roller 122 as a charging device, a development roller 113, a transfer roller 114, and a cleaning device 115. A corona charger can be used as the charging device. The latent image carrier 111 also includes therearound an optical scanning device 117 for conducting optical scanning by means of laser beam LB. The exposure is conducted between the charging roller 112 and the development roller 113 by means of the optical writing. The laser printer 100 also includes a fixing device 116, a cassette 118, a pair of resist rollers 119, a paper feeding roller 120, a transferring path 121, a pair of discharging rollers 122, a tray 123, and a transfer paper P as a recording medium.

When forming an image, the image carrier 111 as a photoconductor is rotated in the clockwise direction at a constant speed. The surface of the carrier 111 is thereby uniformly charged by the charging roller 112, and an electrostatic latent image is formed by receiving the exposure by means of the optical writing of the laser beam LB of the optical scanning device 117. The formed electrostatic latent image is a so-called negative latent image of which an image portion is exposed.

This electrostatic latent image is reversely developed by the development device 113, and the toner image is formed onto the latent image carrier 111.

The cassette 118 in which the transfer papers P are housed is detachably attached to the image forming apparatus 100. In a state where the cassette 18 is mounted on the apparatus 100 as illustrated in FIG. 3, the top transfer paper P housed in the cassette 118 is fed to the paper feeding roller 120. The leading end of the fed transfer paper P is caught by the pair of resist rollers 119. The pair of resist rollers 119 sends the transfer paper P to the transfer unit at the time when the toner image on the image carrier body 111 moves to a transfer position. The sent transfer paper P is overlapped with the toner image in the transfer unit, and the toner image is electrostatically transferred by the operation of the transfer roller 114. The transfer paper P on which the toner image is transferred is sent to the fixing device 116, such that the toner image is fixed by the fixing device 116, and then the transfer paper P is discharged on the tray 123 by the pair of discharging rollers 122 through the transferring path 121. The surface of the image carrier body 111 after which the toner image is transferred is cleaned by the cleaning device 115, and the residual toner, powdered paper and the like are eliminated.

In the image forming apparatus which forms a latent image onto the latent image carrier body 111 by means of optical writing and visualizes the latent image, so as to obtain a desired recorded image, the optical scanning device 117 for optically scanning the latent image carrier body 111 is used, the latent image carrier body 111 is a photoconductor, the electrostatic latent image is formed by uniformed charging and optical scanning, and the formed electrostatic latent image is visualized as a toner image.

According to the embodiment of the present invention, the image reading optical system includes the first optical system and the second optical system for simultaneously reading both sides of the text. Each of the optical systems includes the illumination system, the imaging system, and the line-sensor. When the second optical system is disposed in the automatic text feeding device, the imaging system of the second optical system has an imaging magnification smaller than an imaging magnification of the imaging system of the first optical system. Accordingly, both sides of the text can be automatically read with high accuracy and high speed by the single text transferring operation without damaging the text. For example, when the distance from the text face to the imaging lens is made uniform, the focal length of the imaging lens of the second optical system can be reduced. Thus, the outer shape of the lens is reduced, and the entire optical system can be downsized. Therefore, the optical system can be disposed in the automatic text feeding device.

According to the embodiment of the present invention, when the line-sensor such as a CCD is used as the photoelectric conversion element, the text image is reduced by the imaging system, and is focused onto the surface of the line-sensor. In the present embodiment, the line-sensor is used for each optical system, so the imaging system is a reduced optical system. Therefore, the apparatus can be downsized.

According to the embodiment of the present invention, when the two optical systems are used, the text image on the front face and the text image on the back face can be read by the two optical systems, respectively, by the single text transferring operation. For this reason, the turning-over operation of the text becomes unnecessary, and the problems generated in the transferring such as jamming or skewing can be reduced, and also the reading operation time can be reduced.

According to the embodiment of the present invention, in order to simultaneously read both sides of the text, either the first optical system or the second optical system has to be disposed in one face of the text. In addition, in order to transfer the sheet text, the automatic text feeding device is required. Therefore, according to the present embodiment, either the first optical system or the second optical system is disposed in the automatic text feeding device, so as to read one face of the text. For this reason, the automatic text feeding device is effectively used, and the entire apparatus can be downsized.

According to the embodiment of the present invention, the line-sensor having the zigzag alignment such that the first row and the second row are misaligned at the half pixel is used for either the first optical system or the second optical system. By using such a line-sensor, if the pixel pitches of the line-sensor of the front face and the pixel pitches of the line-sensor of the back face are made uniform, and even if the reading density of the back face is set to be half of the reading density of the front face, the text information of the back face can be read with the reading density equal to the reading density of the front face by calculating the input signals of the first row and the second row of the line-sensor.

According to the embodiment of the present invention, in order to read a full-color image, the color decomposition device such as a filter for decomposing the color into three primary colors is disposed in the optical path. By using a line-sensor for each of the colors, image information decomposed into three colors can be obtained. Therefore, a full color image can be read by the simple device.

According to the embodiment of the present invention, in order to chemically stabilize the imaging lens for the optical system, harmful substances such as lead and arsenic may be contained in the imaging lens. In the present embodiment, by using the optical glass without containing such harmful substances, the material can be recycled, and the water pollution from the waste liquid when processing can be eliminated.

According to the embodiment of the present invention, each of the illumination system, the imaging lens, and the line-sensor for constituting the first optical system includes a specific spectral characteristic, and each of the illumination system, the imaging lens, and the line-sensor for constituting the second optical system includes a specific spectral characteristic. Especially, when reading full-color image information, it is important that the product of the specific spectral characteristics of the illumination system, the imaging lens, and the line-sensor for constituting the first optical system is equal to the product of the specific spectral characteristics of the illumination system, the imaging lens, and the line-sensor for constituting the second optical system. In the present embodiment, the product of the spectral characteristics of the illumination system, the imaging lens, and the line-sensor for constituting the first optical system is almost equal to the product of the spectral characteristics of the illumination system, the imaging lens, and the line-sensor for constituting the second optical system. Consequently, the color-reproducibility on the front face and the back face of the text can be made uniform with high accuracy.

According to the embodiment of the present invention, the image reading optical system is disposed in the image reading apparatus such as a scanner. Therefore, a small image reading apparatus having excellent image reading quality of the front face and the back face of the text can be obtained with low costs. Consequently, the reading productivity on both faces of the text is significantly improved with a simple operation, and the efficiency of the reading operation for both faces of the text is considerably improved, which significantly contributes to the improvement in the appliance.

According to the embodiment of the present invention, the image forming apparatus includes the image reading apparatus of the present embodiment. By means of this structure, since the image is formed based on good image reading quality, a image forming apparatus having high quality is obtained.

According to the present invention, the image reading optical system includes the first optical system for reading one face of the text and the second optical system for reading the other face of the text. The first optical system includes the illumination system for illuminating the text, the imaging system for imaging the reflection light of the text illuminated by the illumination system, and the line-sensor for photoelectrically converting the image of the text imaged by the imaging system, and the second optical system includes the illumination system for illuminating the text, the imaging system for imaging the reflection light of the text illuminated by the illumination system, and the line-sensor for photoelectrically converting the image of the text imaged by the imaging system. The first optical system has an imaging magnification different from an imaging magnification of the second optical system. By means of structure, both faces of the sheet text can be automatically read by the single text transferring operation with high accuracy and high speed without damaging the text.

What is claimed is:

1. An image reading optical system having an automatic text feeding device for automatically reading a front face and a back face of a text, comprising:
a first optical system for reading one face of the text; and
a second optical system for reading the other face of the text,
the first optical system including an illumination system for illuminating the text, an imaging system for imaging reflection light of the text illuminated by the illumination system, and a line-sensor for photoelectrically converting an image of the text imaged by the imaging system, and
the second optical system including an illumination system for illuminating the text, an imaging system for imaging reflection light of the text illuminated by the illumination system, and a line-sensor for photoelectrically converting an image of the text imaged by the imaging system, wherein
the first optical system has an imaging magnification different from an imaging magnification of the second optical system.

2. The image reading optical system according to claim 1, wherein the imaging system of the first optical system is a reduced optical system, and the imaging system of the second optical system is a reduced optical system.

3. The image reading optical system according to claim 1, wherein when the text is a sheet text, the front face and the back face of the sheet text are read by a single transferring of the sheet text.

4. The image reading optical system according to claim 1, wherein either the first optical system or the second optical system is disposed in the automatic text feeding device.

5. The image reading optical system according to claim 1, wherein the line-sensor of either the first optical system or the second optical system has a zigzag alignment.

6. The image reading optical system according to claim 1, wherein the first optical system includes a color decomposition device in an optical path, and the second optical system includes a color decomposition device in an optical path.

7. The image reading optical system according to claim 1, wherein the imaging lens includes an imaging lens having a glass lens, and the glass lens includes a glass material which does not contain a harmful substance.

8. The imaging reading optical system according to claim 6, wherein each of the illumination system, the imaging system and the line-sensor of the first optical system includes a spectral characteristic, and each of the illumination system, the imaging system and the line-sensor of the second optical system includes a spectral characteristic, and a product of each of the spectral characteristics of the illumination system, the imaging system, and the line-sensor of the first optical system is substantially equal to a product of each of the spectral characteristics of the illumination system, the imaging system, and the line-sensor of the second optical system.

9. An image reading apparatus comprising an image reading optical system,
the image reading optical system having an automatic text feeding device for automatically reading a front face and a back face of a text, including:
a first optical system for reading one face of the text; and
a second optical system for reading the other face of the text,
the first optical system including: an illumination system for illuminating the text, an imaging system for imaging reflection light of the text illuminated by the illumination system, and a line-sensor for photoelectrically converting an image of the text imaged by the imaging system, and
the second optical system including an illumination system for illuminating the text, an imaging system for imaging reflection light of the text illuminated by the illumination system, and a line-sensor for photoelectrically converting an image of the text imaged by the imaging system, wherein
the first optical system has an imaging magnification different from an imaging magnification of the second optical system.

10. An image forming apparatus comprising an image reading optical apparatus including an image reading optical system,
the image reading optical system having an automatic text feeding device for automatically reading a front face and a back face of a text, including:
a first optical system for reading one face of the text; and
a second optical system for reading the other face of the text,
the first optical system having an illumination system for illuminating the text, an imaging system for imaging reflection light of the text illuminated by the illumination system, and a line-sensor for photoelectrically converting an image of the text imaged by the imaging system, and
the second optical system having an illumination system for illuminating the text, an imaging system for imaging reflection light of the text illuminated by the illumination system, and a line-sensor for photoelectrically converting an image of the text imaged by the imaging system, wherein
the first optical system has an imaging magnification different from an imaging magnification of the second optical system.
